(19) United States
(12) Patent Application Publication
(10) Pub. No.: US 2026/0315643 A1
(43) Pub. Date: Oct. 15, 2026

(54) CORONA DISINFECTION DEVICE

(71) Applicant: Reviveaire LLC, Kenilworth, NJ (US)

(72) Inventors: Li FENG, Shanghai (CN); Li JUN, Shanghai (CN); Nick AGOPIAN, Madison, WI (US); Linping KUAI, Shanghai (CN); Vincent J. BADALI, Watchung, NJ (US)

(21) Appl. No.: 19/565,010

(22) Filed: Mar. 12, 2026

Related U.S. Application Data
(60) Provisional application No. 63/788,543, filed on Apr. 14, 2025.

(51) Int. Cl. A61L 9/22; A61L 101/24

(52) U.S. Cl. CPC A61L 9/22; A61L 2101/24; A61L 2209/22

(57) ABSTRACT

A corona disinfection device includes a negative plate, a positive plate, a tube having an air inlet and an air outlet opposite the air inlet, and a discharge needle arranged on the positive conductive grid plate. A needle tip of the of the discharge needle is disposed in the tube and extends through the air outlet. A ratio of a distance between the needle tip of the discharge needle and the air inlet of the tube to a total length of the tube is 1/6 to 1/5. The ratio provides the device with an adsorption capacity for particulate matter and microorganisms without extending the length of the tube and/or providing a plurality of layers of dust filter screens, thereby reducing a thickness of the corona disinfection device, saving mounting space, and reducing mounting difficulty.

### CROSS-REFERENCE TO RELATED APPLICATION

The present application claims priority to and the benefit of, under 35 U.S.C. § 119(e), U.S. Provisional Patent Application No. 63/788,543, filed Apr. 14, 2025, which is hereby incorporated by reference in its entirety.

### TECHNICAL FIELD

The present disclosure relates to the field of indoor air purification and disinfection, and in particular, to a corona or plasma-based disinfection device.

### BACKGROUND

Indoor air pollution has become one of the three major environmental pollutions that seriously endanger people's health. Generally, there are several types of indoor air pollution, such as bacterial contamination, fine inhalable particulate pollution, and toxic and harmful gas pollution. Pathogenicity caused by indoor air pollution is an invisible killer that harms people's health.

A corona disinfection technology is an ideal air purification and disinfection technology, which uses a discharge needle to form a corona zone in a metal cylinder to disinfect and sterilize air flowing through the metal cylinder. Meanwhile, a tube wall of the metal cylinder adsorbs charged particulate matter having passed through the corona zone.

However, some existing corona disinfection devices have metal cylinders with poor capacities (namely dust removal capacity) of adsorbing particulate matter and microorganisms. To overcome this deficiency, one feasible solution is to extend a length of the metal cylinder, and another feasible solution is to additionally provide a plurality of layers of dust filter screens on a front side or a rear side of the corona disinfection device. In the above two solutions, a thickness of the disinfection device is increased, thereby needing a larger mounting space and increasing mounting difficulty.

### SUMMARY

To overcome the above shortcoming of existing corona disinfection devices, the present disclosure provides a corona disinfection device, with detailed technical solutions as follows.

In an exemplary embodiment, the present disclosure provides a corona disinfection device including a negative conductive perforated plate and a positive conductive grid plate that are arranged at an interval, where: the negative conductive perforated plate is provided with a plurality of mounting holes, a metal round tube is arranged at each of the mounting holes, an opening at one end of the metal round tube close to the mounting hole is an air inlet, and an opening at the other end of the metal round tube is an air outlet; a plurality of discharge needles in one-to-one correspondence with the metal round tubes are arranged on the positive conductive grid plate, and a needle tip of each of the discharge needles is inserted into a corresponding metal round tube through the air outlet of the metal round tube; and a ratio of a distance between the needle tip of the discharge needle and the air inlet of the metal round tube to a length of the metal round tube is 1/6 to 1/5.

In certain embodiments, the ratio of the distance between the needle tip of the discharge needle and the air inlet of the metal round tube to the length of the metal round tube is set to 1/6 to 1/5, so that a more stable corona zone can be formed at an area of the metal round tube close to the air inlet, which improves an air ionization degree of the corona zone, increases a quantity of electric charges loaded on particulate matter and microorganisms, ultimately enables the particulate matter and microorganisms to be adsorbed and trapped on a tube wall in an adsorption zone, thereby improving an effect of the corona disinfection device in trapping the particulate matter and microorganisms in the air, and/or causes agglomeration of particulate matter and microorganisms that facilitates downstream capture.

In certain embodiments, there is no need to extend the length of the metal round tube and to additionally provide a plurality of layers of dust filter screens, so that a thickness of the corona disinfection device is reduced, thereby saving mounting space and reducing mounting difficulty.

In some embodiments, the length of the metal round tube is 1.25-1.5 times an inner diameter of the metal round tube.

In certain embodiments, the length of the metal round tube is set to 1.25-1.5 times the inner diameter of the metal round tube, so that the adsorption zone formed in the metal round tube can adsorb and trap, and/or cause agglomeration of, the particulate matter and microorganisms in the air, the coaxiality between the discharge needle and the metal round tube is prevented from being reduced due to an excessive length of the adsorption zone, which otherwise ultimately results in excessive ozone release, and an excessive overall thickness of the corona disinfection device is prevented.

In some embodiments, a distance between the positive conductive grid plate and the air outlet of the metal round tube is at least equal to 1/2 of the internal diameter of the metal round tube.

This prevents a too small distance between the positive conductive grid plate and the air outlet of the metal round tube, which otherwise causes air between the positive conductive grid plate and the air outlet of the metal round tube to be completely ionized and conductive, causes the needle tip of the discharge needle to be unable to implement stable discharge, and ultimately leads to reduction of a disinfection and sterilization effect and a dust removal effect of the corona disinfection device.

In some embodiments, a deviation between an axis of the discharge needle and an axis of the corresponding metal round tube does not exceed 0.1 mm.

In certain embodiments, the discharge needle is substantially coaxially arranged with the metal round tube, which can implement uniform discharge of the needle and prevent excessive ozone release.

In some embodiments, a plurality of insulated connecting columns are provided on the positive conductive grid plate, and the negative conductive perforated plate is fixedly connected to the positive conductive grid plate by means of the insulated connecting columns.

In certain embodiments, the positive conductive grid plate is in insulated connection with the negative conductive perforated plate, so that the negative conductive perforated plate remains parallel to the positive conductive grid plate, and structural stability and thickness uniformity of the corona disinfection device are ensured.

In some embodiments, a plurality of metal round tubes are closely arranged on the negative conductive perforated plate in a honeycomb shape.

In certain embodiments, the metal round tubes are closely arranged on the negative conductive perforated plate in the honeycomb shape, so that space utilization of the negative conductive perforated plate is increased, thereby correspondingly increasing an air flow through the corona disinfection device and ultimately improving an air purification effect of the corona disinfection device. In addition, the metal round tubes are closely arranged on the negative conductive perforated plate in the honeycomb shape, so that static pressure drop of the negative conductive perforated plate can be reduced, thereby reducing noise and energy consumption.

In some embodiments, the negative conductive perforated plate and the positive conductive grid plate each are formed from an aluminum alloy plate by cutting, and the negative conductive perforated plate and the positive conductive grid plate have a same thermal expansion coefficient.

In certain embodiments, the negative conductive perforated plate and the positive conductive grid plate are formed from aluminum alloy plates with the same thermal expansion coefficient by cutting, so that it is ensured that the negative conductive perforated plate and the positive conductive grid plate have a good conductive effect, and an excessive deformation difference between the negative conductive perforated plate and the positive conductive grid plate during thermal expansion and contraction is prevented, which otherwise causes a significant change in relative positions of the discharge needle and the metal round tube and causes a decrease in coaxiality between the discharge needle and the metal round tube.

In some embodiments, the metal round tube is formed from an aluminum alloy pipe by cutting or extruded from the same plate as described in any of the previous embodiments.

In an exemplary embodiment, the present disclosure provides a simple manner for manufacturing a metal round tube.

In some embodiments, the needle tip of the discharge needle has a rounded head formed by grinding, and a tail end of the discharge needle is riveted to a grid junction of the positive conductive grid plate.

In certain embodiments, the tail end of the discharge needle is riveted to the grid junction of the positive conductive grid plate, so that mounting firmness of the discharge needle on the positive conductive grid plate can be improved. The needle tip of the discharge needle is ground into the rounded head, so that power generation stability of the needle tip of the discharge needle can be improved.

In some embodiments, the discharge needle is made of a stainless steel-based alloy material, one or more rare earth minerals, and/or one or more trace elements, such as cobalt and vanadium. For example, the discharge needle may be made of 316F stainless steel or 304 stainless steel with rare earth metals. Such materials facilitate formation of few sharp edges on the discharge needle, which lead to ozone generation.

In certain embodiments, on the basis of ensuring discharge performance of the discharge needle, heat resistance, oxidation resistance, and corrosion resistance of the discharge needle are improved, and the service life of the discharge needle is prolonged.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a schematic structural side view of a part of a corona disinfection device according to an embodiment of the present disclosure;

FIG. 2 is a schematic structural top view of a part of the corona disinfection device of FIG. 1; and

FIG. 3 is a schematic structural sectional view of a part of a corona disinfection device of FIG. 1.

FIG. 3A is an alternate mounting arrangement for corona disinfection device.

FIG. 4 is a side view of the tip of a discharge needle constructed of 304 stainless steel with rare earth materials according to an embodiment of the present disclosure obtained using a scanning electronic microscope (SEM).

FIG. 5 is a side view of the tip of a discharge needle constructed of 316F stainless steel according to an embodiment of the present disclosure obtained using an SEM.

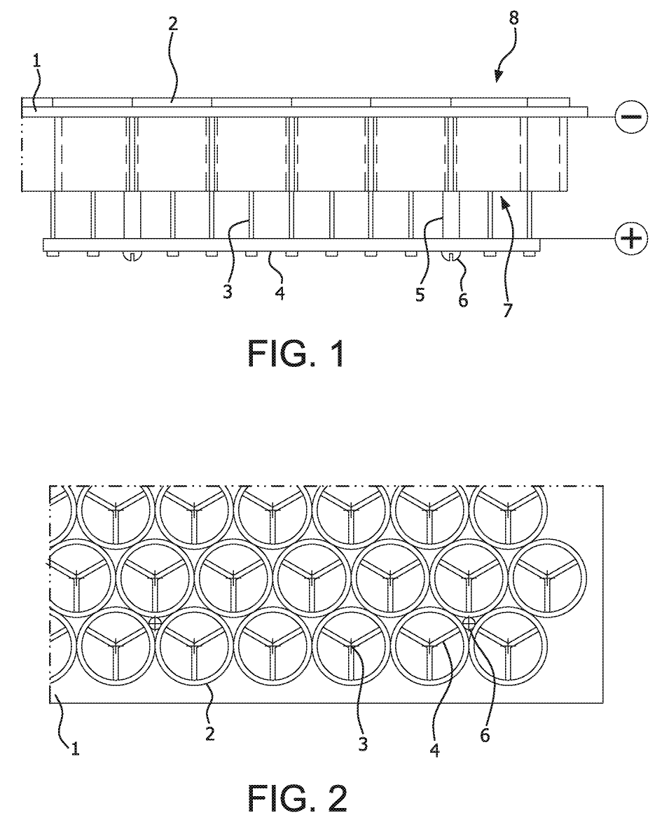

In FIGS. 1-3, the following features are illustrated:

Negative conductive perforated plate 1, metal round tube 2, discharge needle 3, positive conductive grid plate 4, insulated connecting column 5, screw 6, air outlet 7, air inlet 8, corona zone 9, adsorption zone 10, ionic wind 11.

### DETAILED DESCRIPTION

Exemplary embodiments according to the present disclosure is further described in detail below through specific implementations with reference to the accompanying drawings. Associated similar element reference numerals are used for similar elements in different implementations. In the following implementations, many details are described to enable the exemplary embodiments to be better understood. However, those skilled in the art can readily recognize that some of the features may be omitted under different circumstances or replaced by other elements, materials, or methods. In certain cases, some operations related to the exemplary embodiments are not illustrated or described in the specification, to prevent certain aspects of the exemplary embodiment from being obscured by excessive details. For those skilled in the art, a detailed description of these related operations is not necessary, as they can fully understand the relevant operations based on the descriptions in the specification and general technical knowledge in the field.

In addition, the characteristics, operations, or features described in the specification can be combined in any appropriate manner to form various implementations. Meanwhile, the steps or actions in the method description may alternatively be exchanged or adjusted in order in a manner that is obvious to those skilled in the art. Therefore, various orders in the specification and the accompanying drawings each are only for clearly describing an embodiment, and are not meant to be a necessary order, unless otherwise specified, one of the orders has to be followed.

Referring to FIGS. 1-3, a corona disinfection device according to an embodiment of the present disclosure includes a negative plate 1, such as a negative conductive perforated plate 1, which may also be referred to as a negative electrode conductive hole plate, and a positive plate 4, such as a positive conductive grid plate 4, which may also be referred to as a positive electrode conductive mesh plate, that are spaced apart from each other, or arranged at an interval.

The negative conductive perforated plate 1 is provided with a plurality of circular mounting holes, and a tube 2, such as a metal round hollow tube 2, or a non-conductive tube 2 with a conductive inner coating or layer connected to the negative conductive perforated plate, is arranged at each of the mounting holes. An opening at one end of the metal round tube 2 close to the mounting hole is an air inlet 8, and an opening at the other end of the metal round tube 2 is an air outlet 7.

A plurality of discharge needles 3 are arranged on the positive conductive grid 4. Each needle 3 is in one-to-one correspondence with one of the metal round tubes 2, and a needle tip of each of the discharge needles 3 inserted into its corresponding metal round tube 2 through the air outlet 7 of the metal round tube 2. As such, each needle 3 extends from or is electronically connected to the positive conductive grid plate 4 into the air outlet it the tube 2 through the interior of the tube 2 to a location close to the air inlet 8 as will be discussed in more detail below.

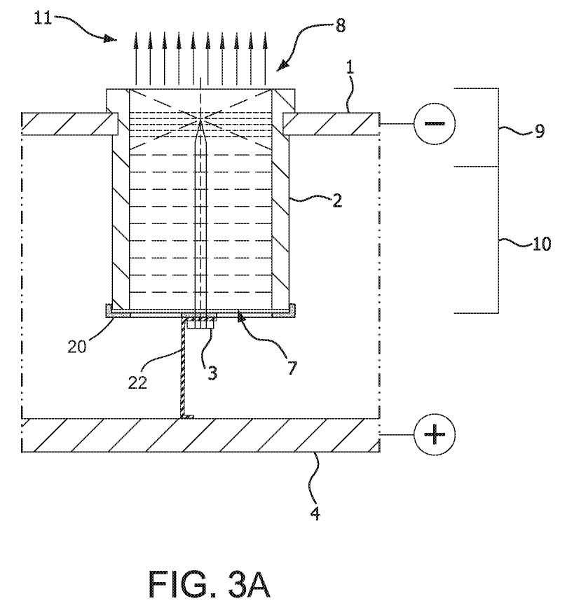

As shown in FIG. 3, an exemplary operation process of the corona disinfection device according to the present disclosure is as follows.

A power supply is switched on, so that a positive electrode and a negative electrode of the power supply are connected to the positive conductive grid plate 4 and the negative conductive perforated plate 1 by means of wires, respectively. The power supply may provide, for example, steady output power at 120V, 220V, up to 10,000V and at 50Hz or 60Hz.

The needle tip of the discharge needle 3 discharges electricity, so that an electric field is formed between the discharge needle 3 and an inner wall of the metal round tube 2. The electric field is divided into a corona zone 9 and an adsorption zone 10. The corona zone 9 is close to the air inlet 8 of the metal round tube 2, and the needle tip of the discharge needle 3 is located in the corona zone 9. The adsorption zone 10 is close to the air outlet 7 of the metal round tube 2. In addition, an ionic wind 11 is formed outside the air inlet 8 of the metal round tube 2. The ionic wind 11 illustratively flows away from the adsorption zone 10 if the highest voltage is provided at the air inlet 8.

Air in the corona zone 9 is ionized, so that a large number of positive and negative ions are formed, to strongly oxidize and disinfect air flowing through the metal round tube 2. Meanwhile, the positive and negative ions condense on the particulate matter and microorganisms, and are ultimately adsorbed on a tube wall in the adsorption zone 10, so as to trap at least some of the particulate matter and microorganisms in the air.

More specifically, non-thermal plasma generates a field of high-energy electrons without significantly increasing the temperature of the surrounding air. When particles pass through this plasma field, several key physical and chemical effects occur. In particular, high energy fields are generated through the device. This occurs without increasing the temperature of the air (accordingly, this is referred to as non-thermal plasma (NTP)). Therefore, as the air with the smaller (sub-micro) particle passes into the tube, physical effects occur: because the NTP produces ions from the fourth state of matter occurring in the plasma zone (or cloud or field), fine and ultrafine particles, such as PM0.3, PM1, or PM2.5, pick up electrical charges as they move through the tube and, as a result, the plasma field. At this point, these smaller particles possess enhanced electrostatic properties making oppositely charged particles interact and attract to each other, making them larger. Such attraction may be referred to as being due to “coulombic forces”. This way, lower efficiency filters act like higher efficiency filters, even HEPA level filters. As this agglomeration occurs where, for example, four PM2.5 filters form a single PM10 filter (or ten PM1.0 filters form a single PM10 filter), these clusters make it easier for lower efficiency filters to act like higher efficiency filters as stated above. These large clusters possess heavier mass. As such, when the device is used without a downstream filter, these heavier particles will be removed from the airflow via sedimentation. Alternately when a downstream filter is used in conjunction with the device, these heavier particles, which may otherwise have not been captured, will now be captured by the filter and removed from the airflow. For example, a MERV 8 filter may acts as a MERV 13 filter, a MERV 13 filter may act as a MERV 16 filter, and a MERV 16 filter may act as a MERV 20 filter.

Particularly, in an embodiment of the present disclosure, a ratio of a distance between the needle tip of the discharge needle 3 and the air inlet 8 of the metal round tube 2 to a total length of the metal round tube 2 is 1/6 to 1/5. In other words, the distance between the needle tip of the discharge needle 3 and the air inlet 8 of the metal round tube 2 accounts for 1/6 to 1/5 of the total length of the metal round tube 2.

If the ratio of the distance between the needle tip of the discharge needle 3 and the air inlet 8 of the metal round tube 2 to the length of the metal round tube 2 is less than 1/6, the needle tip of the discharge needle 3 will be too close to the air inlet 8 and the corona zone 9 will become thin and unstable. In this case, the air ionization degree will be relative low, resulting in reduction of a quantity of electric charges loaded on the particulate matter and microorganisms, and ultimately particulate matter and microorganisms will not be effectively trapped in the adsorption zone 10.

If the ratio of the distance between the needle tip of the discharge needle 3 and the air inlet 8 of the metal round tube 2 to the length of the metal round tube 2 is greater than 1/5, the needle tip of the discharge needle 3 will be too far away from the air inlet 8, and the longer tube body of the metal round tube 2 close to the air inlet 8 cannot cooperate with the discharge needle 3 to generate a sufficient electric field. This leads to decreased effectiveness of the tube body. This ultimately shortens the length of the adsorption zone 10, and ultimately also leads to a decline in a trapping effect on particulate matter and microorganisms.

The ratio of the distance between the needle tip of the discharge needle 3 and the air inlet 8 of the metal round tube 2 to the length of the metal round tube 2 is set to 1/6 to 1/5, to facilitate providing a stable corona zone 9 at the area of the metal round tube 2 close to the air inlet 8. A stable corona which improves the air ionization degree of the corona zone 9, increases the quantity of electric charges loaded on the particulate matter and microorganisms, ensures a sufficient length of the adsorption zone 10, and ultimately enables the particulate matter and microorganisms to be fully adsorbed and trapped on the tube wall in the adsorption zone. This improves the effect of trapping the particulate matter and microorganisms in the air.

The discharge needle 3 and the metal round tube 2 have a substantially coaxial arrangement to facilitate uniform discharge of the needle tip of the discharge needle 3, which can limit release of ozone. As used herein, “substantially coaxial” is understood as meaning that any deviation between an axis of the discharge needle 3 and an axis of the corresponding metal round tube 2 does not exceed 0.1 mm.

In some embodiments, the length of the metal round tube 2 is 1.25-1.5 times an inner diameter of the metal round tube 2.

If the length of the metal round tube 2 is less than 1.25 times the inner diameter of the metal round tube 2, there is a too small length of the adsorption zone 10, and a large amount of particulate matter and microorganisms in the air quickly pass through the adsorption zone 10 under due to cross-sectional velocity. This reduces a trapping rate for the particulate matter and microorganisms, making it difficult to meet one or more air purification requirements.

If the length of the metal round tube 2 is greater than 1.5 times the inner diameter of the metal round tube 2, the length of the adsorption zone 10 increases, so that the articulate matter and microorganisms can be fully adsorbed and trapped in the adsorption zone. However, due to the excessive length of the metal round tube 2 relative to the inner diameter, excessive ozone may be released by the corona disinfection device during operation. In addition, an excessive length of the metal round tube 2 may further lead to an excessive overall thickness of the corona disinfection device, thereby needing a larger mounting space and increasing mounting difficulty. Relatedly, if the tube diameter is too large, the field power is reduced. If the tube is too small, arcing can occur. In certain embodiments, including those that provide ozone for exhaust purposes, the tube diameter may be in a range of 0.5 inches to 2 inches. Further, as the tube diameter increases, more voltage is needed, which can potentially produce ozone.

The length of the metal round tube 2 is set to 1.25-1.5 times the inner diameter of the metal round tube 2, so that the adsorption zone 10 formed in the metal round tube 2 can more fully adsorb and trap the particulate matter and microorganisms in the air. Also, coaxiality between the discharge needle 3 and the metal round tube 2 is inhibited from being reduced due to an excessive length of the adsorption zone 10, which otherwise ultimately results in excessive ozone release, and an excessive overall thickness of the corona disinfection device is inhibited.

In certain embodiments, a distance between the positive conductive grid plate 4 and the air outlet 7 of the metal round tube 2 is at least equal to 1/2 of the internal diameter of the metal round tube 2.

With this arrangement, a too small distance between the positive conductive grid plate 4 and the air outlet 7 of the metal round tube 2 is inhibited. This otherwise causes air between the positive conductive grid plate 4 and the air outlet 7 of the metal round tube 2 to be completely ionized and conductive, causes the needle tip of the discharge needle 3 to be unable to implement stable discharge, and ultimately leads to reduction of both a disinfection and sterilization effect and a dust removal effect of the corona disinfection device.

As shown in FIG. 1, a plurality of insulated connecting columns 5 may be provided between the positive conductive grid plate 4 and the negative conductive perforated plate 1 so as to fixedly connect the positive conductive grid plate 4 to the perforated plate 1 through the insulated connecting columns 5.

In this way, the positive conductive grid plate 4 can be insulatingly coupled with the negative conductive perforated plate 1, so that the positive conductive grid plate 4 remains parallel to the negative conductive perforated plate 1, which facilitates structural stability and thickness uniformity of the corona disinfection device.

The insulated connecting column 5 can be attached to the positive conductive grid plate 4 by means of a screw 6, for example, although other well-known attachment mechanisms could be used. A high-strength plastic connecting column with good insulation performance may be selected as the insulated connecting column 5.

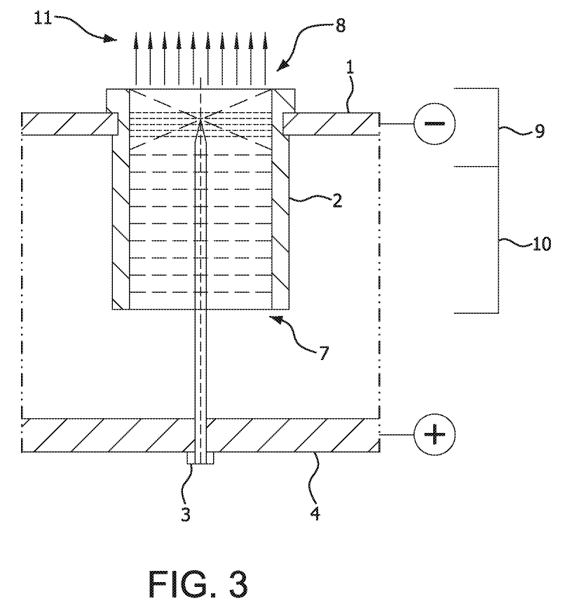

As shown in FIG. 2, the metal round tubes 2 may be closely arranged on the negative conductive perforated plate 1 in a honeycomb arrangement. The metal round tubes 2 are closely arranged on the negative conductive perforated plate 1 in the honeycomb arrangement, so that space utilization of the negative conductive perforated plate 1 is increased, thereby correspondingly increasing an air flow through the corona disinfection device and ultimately improving an air purification effect of the corona disinfection device. In addition, the metal round tubes 2 are closely arranged on the negative conductive perforated plate 1 in the honeycomb arrangement, so that airflow resistance of the negative conductive perforated plate is reduced, thereby reducing noise and energy consumption.

Each metal round tube 2 may be fixed into a corresponding mounting hole in the negative conductive perforated plate 1 by means of a tube expansion and rolling process.

To facilitate manufacturing and provide the negative conductive perforated plate 1 and the positive conductive grid plate 4 with a good conductive effect, the negative conductive perforated plate 1 and the positive conductive grid plate 4 may be formed from an aluminum alloy plate by cutting or punching. Particularly, the negative conductive perforated plate 1 and the positive conductive grid plate 4 preferably have a same thermal expansion coefficient. The plates 1, 4 may have any of various thicknesses, including thicknesses that facilitate efficient manufacturing.

If the negative conductive perforated plate 1 and the positive conductive grid plate 4 have the same thermal expansion coefficient, excessive deformation difference between the negative conductive perforated plate 1 and the positive conductive grid plate 4 during thermal expansion and contraction can be prevented, which otherwise causes a significant change in relative positions of the discharge needle 3 and the metal round tube 2 and disrupts coaxiality between the discharge needle 3 and the metal round tube 2.

The metal round tube 2 may be formed from an aluminum alloy pipe or sheet by cutting or extruding. The negative plate 1 and/or the positive plate 4 may be formed from various aluminum alloys, including 3000 series aluminum, or 5052 aluminum to 7075 aluminum, other conductive materials, such as stainless steel, or other metals higher on the nobility scale.

The needle tip of the discharge needle 3 may have a rounded head formed by grinding (or any other conventional manner), and a tail end of the discharge needle 3 may be riveted to a grid junction of the positive conductive grid plate 4, or attached through any other well-known mounting mechanism. The discharge needle 3 may have any of various diameters. In various embodiments, a ratio of the diameter of the needle to the inner diameter of the tube is in a range of 0.5 to 2.0.

The needle tip of the discharge needle 3 may be provided with the rounded head, so that discharge uniformity of the needle tip of the discharge needle 3 can be further improved. The tail end of the discharge needle 3 is riveted to the grid junction of the positive conductive grid plate 4, so that mounting firmness of the discharge needle 3 on the positive conductive grid plate 4 can be improved. Stated another way, the tail end of the discharge needle 3 is secured to a connection point of struts of the positive conductive grid plate 4.

The positive plate 4 may be a mesh including struts as described above, and the struts form openings therebetween (apart from the discharge needles 3; not shown) having various shapes, such as equilateral triangles, squares, rectangles, diamonds, etc. Connecting strips forming the mesh may have a streamlined design with arc-shaped, step-like shapes, or stepped profiles to reduce (airflow) wind resistance. Openings receiving the discharge needles 3 may be positioned at the intersections of the connecting strips forming the mesh.

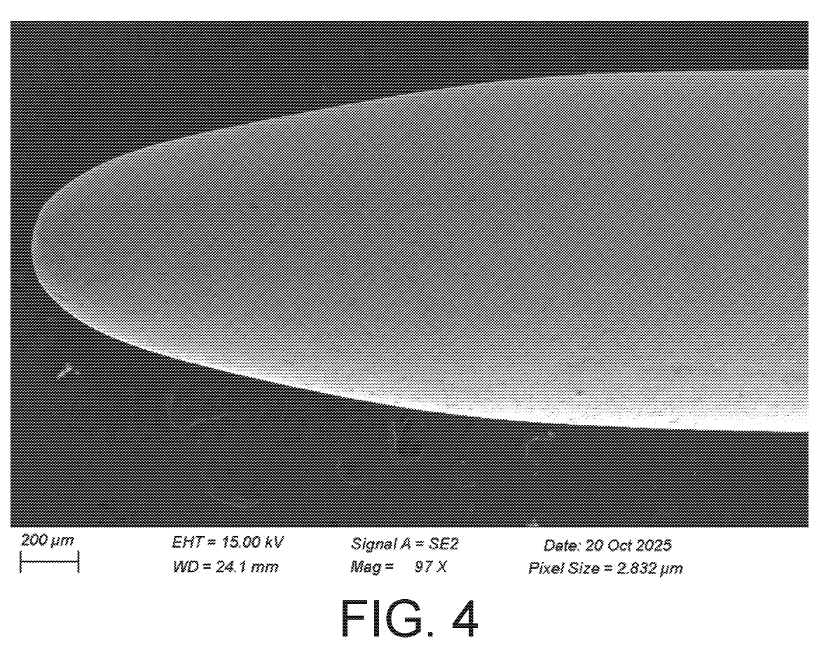

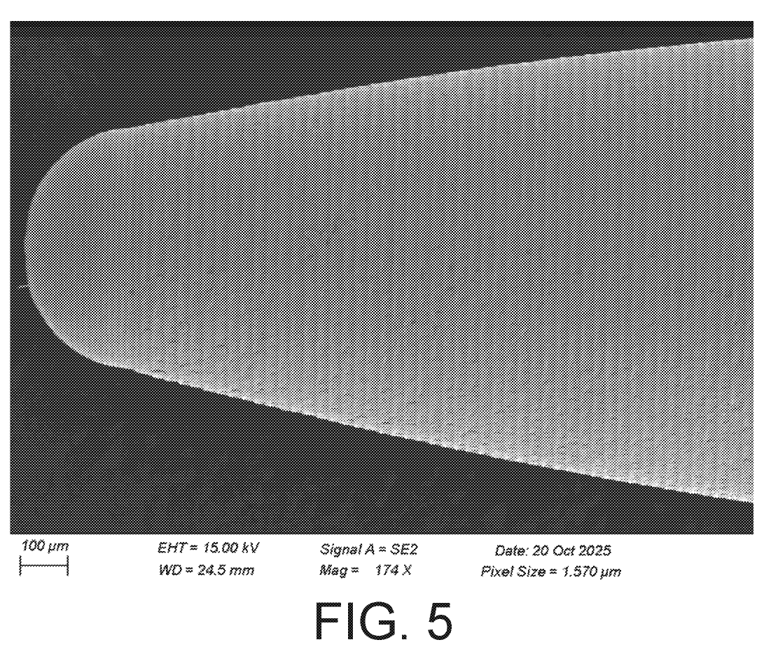

The discharge needle 3 may be made of a stainless steel-based alloy material, for example, 304 to 316F stainless steel, and may include rare earth minerals and/or other trace elements, such as cobalt and vanadium. In particular, 304 stainless steel with rare earth materials surprisingly results in formation of few sharp edges on the discharge needle, which would lead to ozone generation, and, as shown in FIG. 4, such a smooth surface is retained even after a year of use. In contrast, 316F stainless steel provides a relatively rough surface, as shown in FIG. 5. Relatedly, with this arrangement, on the basis of ensuring discharge performance of the discharge needle 3, heat resistance, oxidation resistance, and corrosion resistance of the discharge needle 3 can be improved, and the service life of the discharge needle 3 is prolonged.

Stated another way, corona disinfection devices according to certain embodiments of the present disclosure, particularly the tubes of such devices, advantageously increase the plasma depth in the direction of airflow and slightly increase residence time. This can increase efficiency and provide a more stable field to lower ozone, even at low, or near zero, ozone levels. During adverse conditions, ozone output can increase slightly, but nevertheless comply with UL-2998. U

Corona disinfection devices according to certain embodiments of the present disclosure advantageously improve indoor air quality in one or more of the following manners: reducing mold in residential settings by up to 97.5%; reducing bacteriophage MS2 by 97.2% in 60 minutes (ASHRAE Standard 241 compliance); reducing SARS-CoV-2 by 99.97% in 60 minutes; reducing staphylococcus albus by 99.99% in two hours; achieving inactivity rate of 99.7% for Phi-X174 in 60 minutes; achieving kill rate of 97.7% for s. epidermidis in two hours; reducing H1N1 by 99.99% in one hour; providing low flow rate ozone emissions of 0.935 PPB (eight hour time weighted average); providing high flow rate ozone emissions of 0.598 PPB (eight hour time weighted average); generating no ozone in an ASHRAE Standard 241, 24 hour ozone test (average ozone concentration – 2.33 ppb); generating less than 1 ppb ozone in a UL-2998 test; if used together with a MERV8 filter, achieving similar performance as a MERV13 in two hours; effectively capturing particles down to 0.3-0.7 microns, which is the typical particle size of wildfire smoke; achieving filtration performance comparable to HEPA levels, for example, effectively capturing particles down to 0.3 microns; reducing radon levels; reducing or eliminating odor producing cannabis compounds.

In various embodiments, corona disinfection devices according to embodiments of the present disclosure may be controlled (that is, operated or modulated) using any of various types of communication methods and/or user interfaces, such as Bluetooth, 5G, near field communication (NFC), Wi-Fi, a smartphone-based application, or a web browser-based application. Such interfaces may provide status indications for operation and/or alarms, and may facilitate modulating devices based on indoor air quality. Relatedly, such features may be integrated into building management systems (BMSs).

In various embodiments, corona disinfection devices may be operated based on signals received from one or more indoor air quality sensors. In particular, the sensors may output signals that cause corona disinfection devices to increase or decrease performance based on an increased or decreased load, respectively. As a specific example, virus sensors may output signals that cause corona disinfection devices to increase performance based on an increased presence of a virus in the environment of the sensors. Signals provided by such sensors may be in a range of 4-20 mA or 1(0)-10 V.

Corona disinfection devices according to the present disclosure may be modified in various other manners. For example, as shown in FIG. 3A, the upstream or downstream ends of the tubes may include insulating supports 20 that couple to or support the discharge needles, and the needles may electrically couple to the positive plate via wires or cables 22.

Exemplary embodiments have been described above in sufficient detail with certain particularity. It should be understood by those of ordinary skill in the art that the descriptions in the embodiments are only exemplary, and all changes made without deviating from the true spirit and scope of the present disclosure should fall within the protection scope. The protection scope of the present disclosure is defined by the claims, not by the above descriptions.

What is claimed is:

1. A corona disinfection device, comprising:
a negative conductive perforated plate including a plurality of mounting holes;
a positive conductive grid plate spaced apart from the negative conductive perforated plate;
a tube arranged at each of the mounting holes, the tube having an air inlet proximate the mounting hole and an air outlet opposite the air inlet; and
a plurality of discharge needles arranged on the positive conductive grid plate, each needle associated with a corresponding one of the tubes and extending from the positive conductive plate into the air outlet of the tube and having a needle tip located within the tube;
wherein a ratio of a distance between the needle tip of the discharge needle and the air inlet of the tube to a total length of the tube is 1/6 to 1/5.

2. The corona disinfection device according to claim 1, wherein the total length of the tube is 1.25-1.5 times an inner diameter of the tube.

3. The corona disinfection device according to claim 1, wherein a distance between the positive conductive grid plate and the air outlet of the tube is at least 1/2 of the internal diameter of the tube.

4. The corona disinfection device according to claim 1, wherein a deviation between an axis of the discharge needle and an axis of the tube does not exceed 0.1 mm.

5. The corona disinfection device according to claim 1, wherein a plurality of insulated connecting columns couple the positive conductive grid plate and the negative conductive perforated plate.

6. The corona disinfection device according to claim 1, further comprising a plurality of tubes including the tube, the plurality of tubes being positioned in a honeycomb arrangement.

7. The corona disinfection device according to claim 1, wherein the negative conductive perforated plate and the positive conductive grid plate comprise an aluminum alloy.

8. The corona disinfection device according to claim 1, wherein the tube comprises an aluminum alloy.

9. The corona disinfection device according to claim 1, wherein the needle tip of the discharge needle has a rounded head.

10. The corona disinfection device according to claim 1, wherein the discharge needle comprises a stainless steel-based alloy material.

11. The corona disinfection device according to claim 1, wherein the negative conductive perforated plate and the positive conductive grid plate have a same thermal expansion coefficient.

12. The corona disinfection device according to claim 1, further comprising a rivet coupling a tail end of the discharge needle to a grid junction of the positive conductive grid plate.

13. A corona disinfection device, comprising:
a first conductive plate including a plurality of mounting holes;
a second conductive plate spaced apart from the first conductive plate;
a tube arranged at each of the mounting holes, the tube having an air inlet proximate the mounting hole and an air outlet opposite the air inlet; and
a plurality of discharge needles electrically connected to the second conductive plate, each needle associated with a corresponding one of the tubes and extending into the air outlet of the tube and having a needle tip located within the tube;
wherein a ratio of (I) a distance between the needle tip of the discharge needle and the air inlet of the tube to (II) a total length of the tube is between about 1/6 to about 1/5.

14. The corona disinfection device according to claim 13, wherein the total length of the tube is about 1.25-1.5 times an inner diameter of the tube.

15. The corona disinfection device according to claim 13, wherein a distance between the second conductive plate and the air outlet of the tube is at least 1/2 of the internal diameter of the tube.

16. The corona disinfection device according to claim 13, wherein a deviation between an axis of the discharge needle and an axis of the tube does not exceed about 0.1 mm.

17. The corona disinfection device according to claim 13, wherein the first conductive plate and the second conductive plate comprise an aluminum alloy.

18. The corona disinfection device according to claim 13, wherein the discharge needle comprises a stainless steel-based alloy material.

19. The corona disinfection device according to claim 13, wherein the first conductive plate and the second conductive plate have a same thermal expansion coefficient.

20. The corona disinfection device according to claim 13, wherein a tail end of the discharge needle is attached to a grid junction of the second conductive plate.
